(19) United States
(12) Patent Application Publication
(10) Pub. No.: US 2018/0005057 A1
(43) Pub. Date: Jan. 4, 2018

(54) APPARATUS AND METHOD FOR CAPTURING FACE IMAGE OF DECREASED REFLECTION ON SPECTACLES IN VEHICLE

(71) Applicant: Hyundai Motor Company, Seoul (KR)

(72) Inventors: Byoung Joon Lee, Suwon (KR); Seong Sook Ryu, Seoul (KR); Jin Kwon Kim, Suwon (KR); Ho Choul Jung, Suwon (KR); Sam Yong Kim, Hwaseong (KR)

(21) Appl. No.: 15/336,711

(22) Filed: Oct. 27, 2016

(30) Foreign Application Priority Data
Jul. 1, 2016 (KR) 10-2016-0083648

(51) Int. Cl. G06K 9/00; H04N 5/232; B60R 1/00; H04N 5/235

(52) U.S. Cl. CPC G06K 9/00845; H04N 5/2353; H04N 5/2351; H04N 5/23219; B60R 1/00; G06K 9/00281; G06K 9/00255; G06K 9/00604; B60R 2300/103

(57) ABSTRACT

An apparatus and a method for capturing a face image are provided. The apparatus and method determine a reflection on spectacles of a region around an eye within a face of a driver in real time and more stably and effectively reduce an influence of the reflection from the spectacles through an exposure control, without requiring an output for a difference image. In particular, an imaging device is operated by performing an external exposure control to reduce the reflection on the spectacles in a vehicle to receive lighting on/off images and performing a difference image processing in an electronic control unit (ECU).

### CROSS-REFERENCE TO RELATED APPLICATION

This application is based on and claims the benefit of priority to Korean Patent Application No. 10-2016-0083648, filed on Jul. 1, 2016 in the Korean Intellectual Property Office, the disclosure of which is incorporated herein in its entirety by reference.

### TECHNICAL FIELD

The present disclosure relates to an apparatus and a method for capturing a face image, and more particularly, to an apparatus and a method for capturing a face image that determine a reflection on spectacles of a region around an eye within a face of a driver in real time in a vehicle which is being driven and more stably and effectively reduce an influence of the reflection from the spectacles based on a difference image through an exposure control.

### BACKGROUND

Recent developments for providing services having increased convenience for a driver have increased in which face images are captured of a driving within a vehicle to provide, for example, a warning of a gaze direction when a driver is not facing a driving direction, detecting the number of passengers who enter the vehicle, detecting a face state of the driver of the vehicle, etc.

A conventional apparatus for capturing a face image, that is, recognizing an eye position of the driver or open and close state of the eye has a problem in that when the driver wears spectacles or eyeglasses in the daytime, a recognition ratio is significantly decreased due to a reflection of the light of the sun from an eye region. Accordingly, an apparatus of the related art attempts to remove an influence of disturbance light using a difference image according to lighting on/off. However, since the apparatus for capturing a face image according to the related art is required to have a rapid photographing time or is required to have a mass memory for storing images, it is often costly to practically implement the apparatus for capturing a face image. Therefore, a method for capturing a face image that more stably and effectively reduces an influence of a reflection from the spectacles in real time in the vehicle which is being driven is demanded.

### SUMMARY

The present disclosure provides an apparatus and a method for capturing a face image that may determine a reflection on spectacles of a region around an eye within a face of a driver in real time and may more stably and effectively reduce an influence of the reflection from the spectacles through an exposure control, without requiring an output for a difference image, by operating an imaging device configured to perform a external exposure control for purpose of reducing the reflection on the spectacles in a vehicle to receive lighting on/off images and perform a difference image processing in an electronic control unit (ECU).

According to an exemplary embodiment of the present disclosure, an apparatus for capturing a face image for monitoring a driver state in a vehicle may include: an imaging device (e.g., a camera, video camera, or the like); an electronic control unit (e.g., a controller) configured to perform an exposure control for the imaging device; and one or more light devices which are turned on or off by the imaging device or the electronic control unit, wherein the electronic control unit may be configured to determine whether brightness for a predetermined region within a face is saturated in an image captured by the imaging device, and determine whether to use a difference image between a lighting on image and a lighting off image.

The electronic control unit may be configured to determine whether the brightness is saturated in an eye detection candidate region based on the lighting on image captured by the imaging device when the light device is turned on. The electronic control unit may include: a driver state recognizer configured to determine whether the brightness is saturated and calculate the difference image; and a capture controller configured to capture the lighting off image and the lighting on image from the imaging device according to a control of the driver state recognizer (e.g., capture one image with the light device off and one image with the light device on). The electronic control unit may further be configured to perform a face detection in the lighting on image, and perform an eye detection based on the difference image in a condition in which no the brightness is saturated. The electronic control unit may be configured to perform an eye detection based on the lighting on image in a condition in which the brightness is saturated, calculate a saturation prevention exposure value of the eye detection candidate region to perform the exposure adjustment of the imaging device, and perform the eye detection based on the lighting on image which is re-photographed by the imaging device.

Whether the brightness is saturated may be determined for the eye detection candidate region when the driver wears the spectacles in the daytime. The electronic control unit may be configured to determine that the brightness is saturated when the number of pixels having predetermined brightness or greater within the eye detection candidate region in the lighting on image is a threshold value or greater. The electronic control unit may further be configured to perform an eye detection based on the lighting on image in a condition in which the brightness is saturated, and calculate a saturation prevention exposure value of the eye detection candidate region within a predetermined range for a brightness average within the eye detection candidate region in the lighting on image to perform the exposure adjustment of the imaging device.

The electronic control unit may be configured to perform an eye detection based on the difference image in a condition in which no the brightness is saturated, and capture the lighting off image by maintaining an exposure value for the imaging device when a brightness average of the lighting on image is within a predetermined range. Additionally, the electronic control unit may be configured to perform an eye detection based on the difference image in a condition in which no the brightness is saturated, operate the imaging device to decrease an exposure value for the imaging device when a brightness average of the lighting on image is greater than an upper limit value of a predetermined range, and capture the lighting off image. The electronic control unit may be configured to operate the imaging device by increasing an exposure value for the imaging device when a brightness average of the lighting on image is a lower limit value or less of a predetermined range in a condition in which no the brightness is saturated, and perform an eye detection based on the lighting on image.

According to another exemplary embodiment of the present disclosure, a method for capturing a face image for monitoring a driver state in a vehicle may include: performing an exposure adjustment for an imaging device installed within the vehicle; turning on or turning off one or more light devices installed within the vehicle; and determining whether brightness for a predetermined region within a face is saturated in an image captured by the imaging device, and determining whether to use a difference image between a lighting on image and a lighting off image.

Whether the brightness is saturated in an eye detection candidate region may be determined based on the lighting on image captured by the imaging device when the light device is turned on. Additionally, a face detection may be performed in the lighting on image (e.g., image capture when the light device is turned on), and an eye detection may be performed based on the difference image in a condition in which no the brightness is saturated. An eye detection may be performed based on the lighting on image in a condition in which the brightness is saturated, a saturation prevention exposure value of the eye detection candidate region may be calculated to perform the exposure adjustment of the imaging device, and the eye detection may be performed based on the lighting on image which is re-photographed by the imaging device.

Further, the brightness may be determined to be saturated when the number of pixels having predetermined brightness or greater within the eye detection candidate region in the lighting on image is a threshold value or greater. An eye detection may be performed based on the lighting on image when the brightness is saturated, and a saturation prevention exposure value of the eye detection candidate region may be calculated within a predetermined range for a brightness average within the eye detection candidate region in the lighting on image to perform the exposure adjustment of the imaging device. An eye detection may be performed based on the difference image in a condition in which no the brightness is saturated, and the lighting off image may be captured (e.g., image captured when the light device is turned off) by maintaining an exposure value for the imaging device when a brightness average within the eye detection candidate region in the lighting on image is within a predetermined range.

An eye detection may be performed based on the difference image in a condition in which no the brightness is saturated, the imaging device may be operated to decrease an exposure value for the imaging device when a brightness average of the lighting on image is greater than an upper limit value of a predetermined range, and the lighting off image may be captured. The imaging device may be operate by increasing an exposure value for the imaging device when a brightness average of the lighting on image is a lower limit value or less of a predetermined range in a condition in which no the brightness is saturated, and an eye detection may be performed based on the lighting on image.

### BRIEF DESCRIPTION OF THE DRAWINGS

The above and other objects, features and advantages of the present disclosure will be more apparent from the following detailed description taken in conjunction with the accompanying drawings.

FIG. 1 is a diagram illustrating an apparatus for capturing a face image according to an exemplary embodiment of the present disclosure;

FIG. 2 is a diagram illustrating an operation concept of a capture controller and a driver state recognizer of FIG. 1 according to an exemplary embodiment of the present disclosure;

FIG. 3 is a diagram which illustrates in more detail an exposure control logic for a difference image in the driver state recognizer of FIG. 1 according to an exemplary embodiment of the present disclosure;

FIGS. 4A-4C are photographs showing comparison results of a degree of brightness saturation between an original lighting on image and a difference image according to an exemplary embodiment of the present disclosure;

FIG. 5 is a photograph showing a comparison result of an original image of a general camera and an image according to a reduction effect of a reflection on spectacles according to an exemplary embodiment of the present disclosure; and

FIG. 6 is a diagram illustrating an example of a method for implementing a capture controller of the apparatus for capturing a face image according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, the present disclosure will be described in detail with reference to the accompanying drawings. Here, like reference numerals denote like elements in the respective drawings. In addition, a detailed description of functions and/or configurations which are already known will be omitted. The contents disclosed below mainly describe portions necessary to understand operations according to various exemplary embodiments and a description of elements which may obscure the gist of the description will be omitted. In addition, some components shown in the drawings may be exaggerated, omitted or schematically illustrated. The size of each component does not exactly reflect its real size and accordingly, the contents described in this specification are not limited by relative sizes or intervals of the components illustrated in the respective drawings.

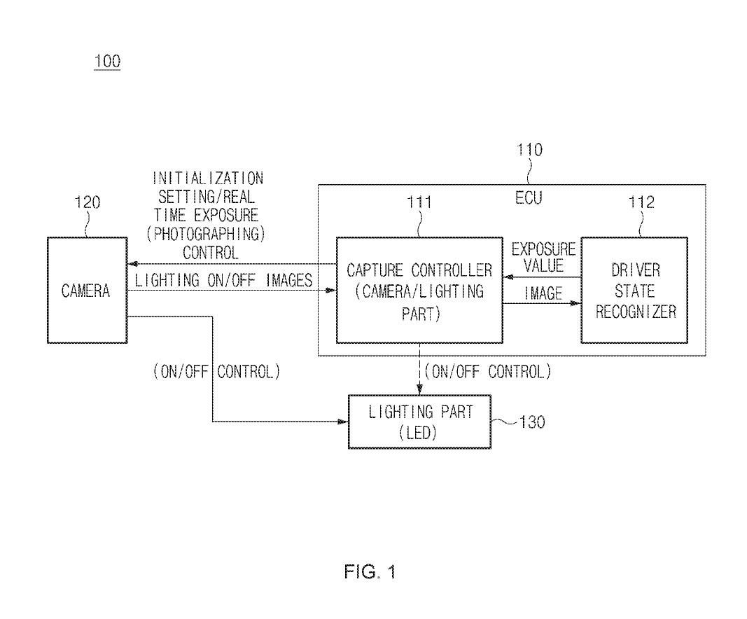

FIG. 1 is a diagram illustrating an apparatus (100) for capturing a face image according to an exemplary embodiment of the present disclosure. Referring to FIG. 1, the apparatus 100 for capturing a face image according to an exemplary embodiment of the present disclosure which may be installed to perform a reduction of a reflection on spectacles when a driver state monitoring (DSM) of a driver in a vehicle is performed, may include an electronic control unit (e.g., controller or ECU) 110, an imaging device (e.g., a camera, video camera, or the like) 120, and a lighting part 130. The electronic control unit 110 may include a capture controller 111 configured to operate the imaging device 120 or the lighting part (e.g., light device) 130, and a driver state recognizer 112 configured to perform the driver state monitoring (DSM) of the driver such as an eye position of the driver, an open and close thereof, or the like.

The above-mentioned imaging device 120 may be a digital camera as an apparatus for capturing a photographed capture image. Hereinafter, an example in which the lighting part 130 is a light emitting diode (LED) lighting as one or more apparatuses for radiating light such as front light, side light, and the like, will be described. This is illustrative, and as the imaging device 120, other types of apparatuses for capturing an image may be used, and as the lighting part 130, other types of apparatuses for radiating light may be used. The electronic control unit 110 may be configured to execute a general control, may be hardware such as a semiconductor processor, and may be operated together with an execution of software such as an application program, or the like, if necessary.

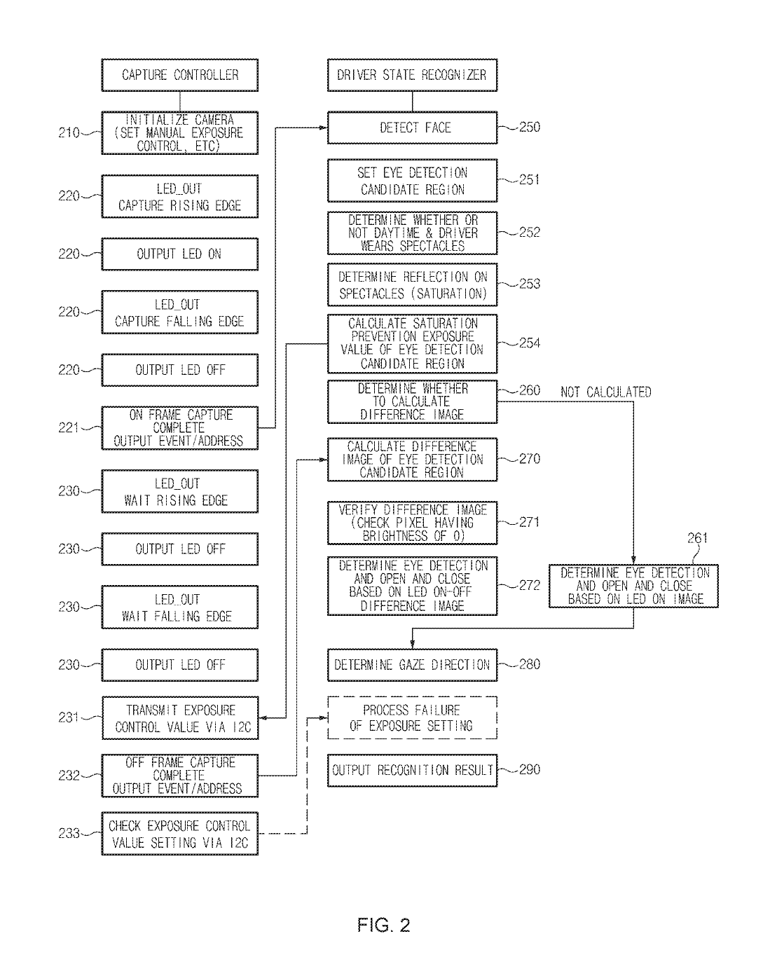

FIG. 2 is a diagram illustrating an operation concept of the capture controller 111 and the driver state recognizer 112 of FIG. 1. The capture controller 111 may be configured to set 210 initialization values (e.g., an exposure value for an exposure control of an aperture upon performing a manual photographing, etc.) for operating the imaging device 120, operate the imaging device 120 and the lighting part 130 to capture 221 (e.g., it is possible to generate a capture complete event message/address) a corresponding lighting on (frame) image (data) for a face of the driver between a rising edge and a falling edge of a lighting turn-on control signal during 220 a turn-on of the lighting (e.g., front light/side light) of the lighting part 130, and may be configured to capture 232 (e.g., it is possible to generate the capture complete event message/address) a corresponding lighting off (frame) image (data) for the face of the driver between a rising edge and a falling edge of a lighting turn-off control signal during 230 a turn-off of the lighting of the lighting part 130.

However, in accordance with a saturation prevention exposure value 231 of an eye detection candidate region calculated by determining, by the driver state recognizer 112 based on the lighting on image (e.g., the face image of the driver during the turn-on of the lighting part 130), the capture controller 111 may be configured to operate the imaging device 120 to capture the lighting on/off image. The capture controller 111 may be configured to detect the setting of the exposure control value for the imaging device 120, and when the exposure control value does not meet a predetermined condition, the capture controller 111 may be configured to transmit a signal (the exposure value) to the driver state recognizer 112, to allow a failure of the exposure setting to be processed and to inform the exposure control value to be again set (233). The predetermined condition is the exposure value transmitted to the camera in the step 231. The capture controller 111 may decide whether exposure of the camera is set by the exposure value transmitted to the camera in the step 231.

Accordingly, the exposure adjustment of (aperture) and the photographing of the imaging device 120 may be adjusted based on the exposure control value of the capture controller 111, and the lighting of the lighting part 130 may be turned on/off based on the lighting control value (signal) of the capture controller 111. Similarly to a general camera function, when the capture controller 111 transmits the exposure control value to the imaging device 120, the imaging device 120 may be configured to perform the exposure control and capture the image according to the corresponding control value. In addition, the imaging device 120 may also be configured to operate the lighting part 130 to turn on/off the lighting of the lighting part 130 at an appropriate timing.

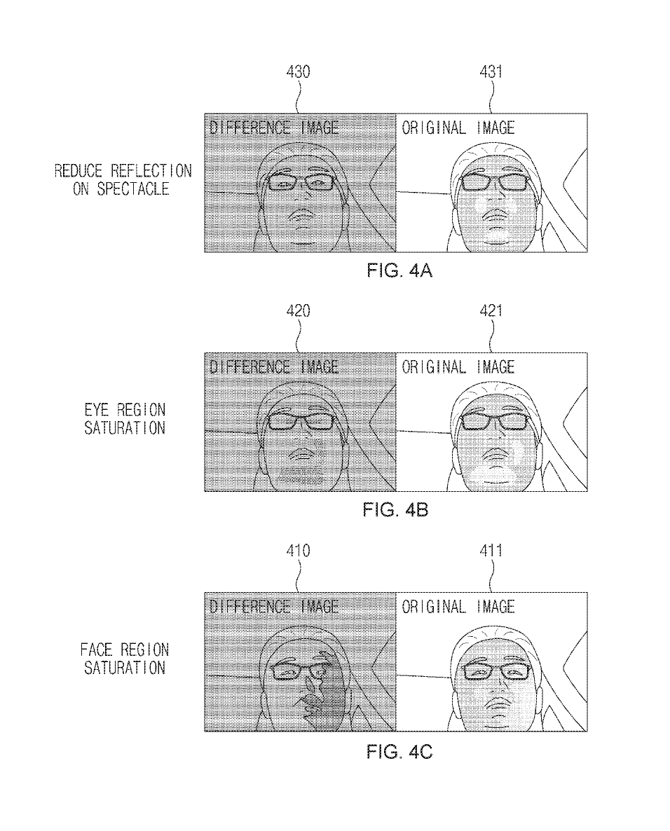

The driver state recognizer 112 may be configured to detect a face portion from the lighting on (frame) image for the face of the driver which is less influenced by an incidence of the light of the sun (250). In other words, when the reflection by the spectacles of the driver is severe in the daytime, since a difference image of a portion in which brightness is saturated exhibits black (see FIGS. 4A-4C), an exposure control is required in real time to prevent brightness of an eye portion from being particularly saturated. Accordingly, since an image of the imaging device 120 having a reduced exposure has some regions of the face which are dark, it may be difficult to detect the face. Therefore, the face detection may be performed in the lighting on (frame) image.

The driver state recognizer 112 may further be configured to detect 252 that the driver wears the spectacles in the daytime in the preset eye detection candidate region 251, determine 253 whether brightness of the eye portion is saturated (e.g., the saturation by the reflection on the spectacles), and perform the eye detection, that is, the eye position and open and close recognition based on the difference image between the lighting on/off images when no brightness of the eye portion is saturated. The driver state recognizer 112 may be configured to calculate the saturation prevention exposure value of the eye detection candidate region based on the lighting on image and provide the saturation prevention exposure value to the capture controller 111. When the brightness of the eye portion is saturated in the lighting on image, the driver state recognizer 112 may be configured to calculate an exposure value decreasing the exposure and provide the calculated exposure value (254) to the capture controller 111.

Accordingly, the capture controller 111 may be configured to operate the imaging device 120 to again capture the lighting on image, and also capture the lighting off image when no the brightness of the eye portion is saturated based on the control of the driver state recognizer 112. The driver state recognizer 112 may be configured to determine that the calculation of the difference image is performed when no the brightness of the eye portion is saturated in the lighting on image 260, and perform the eye position and open and close recognition based on the difference image between the lighting on/off images. When the brightness of the eye portion is saturated, the driver state recognizer 112 may be configured to perform the eye position and open and close recognition using the lighting on image 261.

The driver state recognizer 112 may further be configured to calculate the difference image between the lighting on/off images for the eye detection candidate region 270, and then verify whether the eye position and open and close recognition is performed using the difference image 271. For example, when a pixel having the brightness of 0 (or a brightness difference between the lighting on/off images of 0) is present in the difference image, since no brightness is saturated and a motion of a subject (the face of the driver) is minimal, the eye detection, that is, the eye position and open and close recognition may be performed using the difference image 272. When the motion of the subject is severe on characteristics of the difference image (e.g., images of a side portion based on ears and a cheek of the face), the driver state recognizer 112 may be configured to operate the capture controller 111 to immediately capture an image which is dedicated to the eye detection and capture a re-photographed image for the eye portion, thereby making it possible to perform the eye position and open and close recognition.

The driver state recognizer 112 may be configured to determine the eye position and the open and close thereof according to a predetermined algorithm using the lighting on image or the difference image in the above-mentioned way to determine a gaze direction of the driver 280, and provide information on the eye position and the open and close thereof, and the recognized result such as the gaze direction to other application parts 290. For example, the application parts may include various units for providing services having increased convenience of the driver by capturing face images in the vehicle such as an output unit of warning a driver regarding a gaze direction when the gaze direction is detected to be different from a driving direction, a sensor configured to detect the number of passengers who enter the vehicle, a sensor configured to detect a face state of the driver of the vehicle, etc.

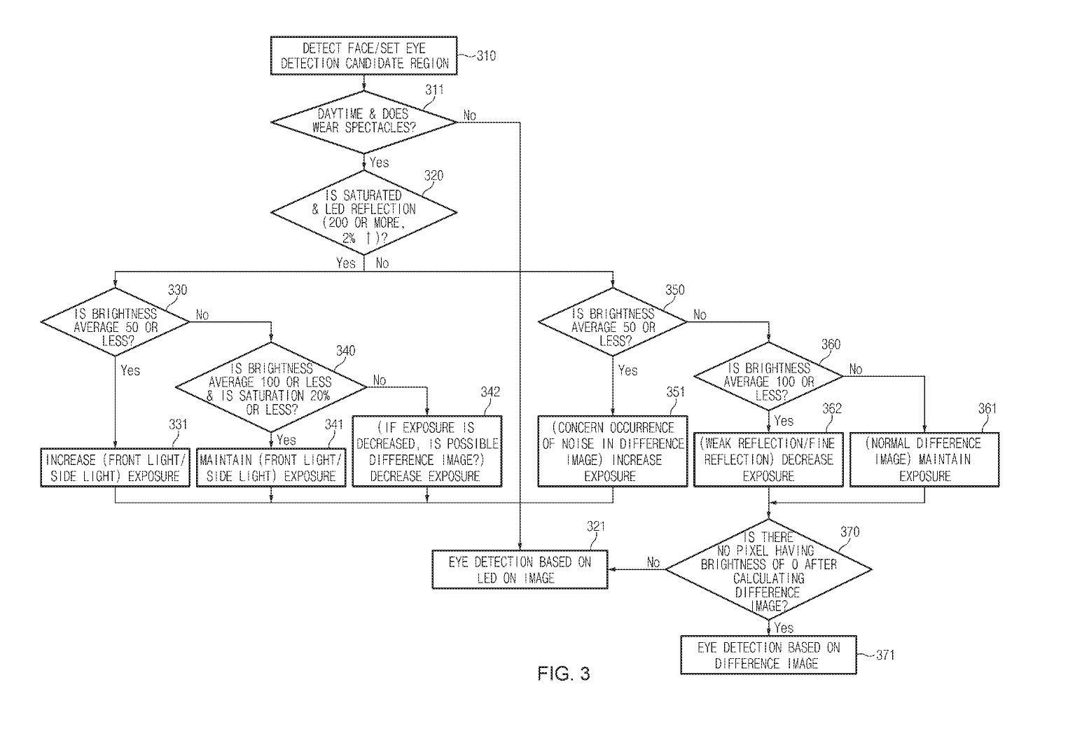

FIG. 3 is a diagram which illustrates in more detail an exposure control logic for the difference image in the driver state recognizer 112 of FIG. 1. First, when the capture controller 111 adjusts the exposure and the photographing of the imaging device 120 and captures the lighting on (frame) image for the face of the driver which is less influenced by the incidence of the light of the sun, the driver state recognizer 112 may be configured to detect the face portion from the corresponding lighting on image and set the eye detection candidate region having a predetermined range including both eyes of the driver for the corresponding image 310. When necessary, the driver state recognizer 112 may also be configured to detect the face portion from the lighting off image and set the eye detection candidate region.

The driver state recognizer 112 may be configured to detect 311 whether the driver wears the spectacles in the daytime in the set eye detection candidate region, determine 320 whether brightness of the eye portion is saturated (the saturation by the reflection of the spectacles), and perform the eye position and open and close recognition based on the difference image between the lighting on/off images when no brightness of the eye portion is saturated. When the driver is detected to not be wearing the spectacles or when dark lighting conditions are detected, the driver state recognizer 112 may be configured to perform the eye position and open and close recognition using the lighting (e.g., LED) on image 321. For example, whether the brightness of the eye portion is saturated (the saturation by the reflection of the spectacles) may be a case in which the number of pixels having predetermined brightness or greater (e.g., about 200 or more in 0 to 256 gradations) within the eye detection candidate region in the lighting on image is a threshold or greater (e.g., about 2% or more).

When the brightness of the eye portion is saturated in the lighting on image, the driver state recognizer 112 may be configured to provide an exposure value decreasing the exposure to the capture controller 111. In particular, the exposure value may be tuned to a range in which a variation of the exposure value is not severe and an eye detection is well performed. For example, a brightness average (e.g., except for a reflection portion of the gradation of about 200 or greater and a background portion of the gradation of about 20 or less) of the lighting on image may be guided within an interval of the gradations of about 50 to 100.

For example, when the brightness average (e.g., except for a reflection portion of the gradation of about 200 or greater and a background portion of the gradation of about 20 or less) of the lighting on image has the gradation of about 50 or less 330, the driver state recognizer 112 may be configured to generate a control signal to maintain the lighting for front light or side light in the lighting part 130, and generate the control signal to increase the exposure value to provide the control signal to the capture controller 111. The driver state recognizer 112 may further be configured to perform the eye position and open and close recognition using the lighting (e.g., LED) on image again photographed by the imaging device according to the above-mentioned control 321. To protect the LED of the lighting part 130 and prevent a low exposure thereof, the range of the exposure value in the driver state recognizer 112 may be limited to predetermined upper and lower limit values (e.g., about 2 to 6 in Gain 2×), and may be gradually changed in a predetermined step unit (e.g., ±1 step) when the exposure value is again adjusted.

In the operation 330, when the brightness average of the lighting on image is greater than the gradation of about 50, the brightness average of the lighting on image is the gradation of about 100 or less, and when the brightness of the eye portion is saturated (the saturation by the reflection by the spectacles) when the number of pixels having predetermined brightness or greater (e.g., about 200 or more in gradations of 0 to 256) in the lighting on image in the eye detection candidate region is a predetermined threshold (e.g., about 20%) or greater (340), the driver state recognizer 112 may be configured to generate the control signal to maintain the lighting for front light or side light in the lighting part 130, and generate the control signal to maintain the exposure value without being changed to provide the control signal to the capture controller 111 (341). For example, when a sun visor in the vehicle is not pulled down, since it may be difficult for the brightness average to show the gradation of about 200 or less due to the front light, an exception condition such as the case in which the number of pixels having the gradation of about 200 or more is the threshold (e.g., about 20%) or greater as described above was added. The driver state recognizer 112 may be configured to perform the eye position and open and close recognition using the lighting (e.g., LED) on image again photographed by the imaging device 120 according to the above-mentioned control 321.

When the condition in the operation 340 is not satisfied, the driver state recognizer 112 may be configured to generate the control signal to maintain the lighting for the front light or the side light in the lighting part 130, and generate the control signal to decrease the exposure value to provide the control signal to the capture controller 111 (342). When the exposure value is decreased as described above, the saturation of the brightness of the eye portion may be removed, thereby making it possible to perform the eye detection based on the difference image. The driver state recognizer 112 may be configured to perform the eye position and open and close recognition using the lighting (e.g., LED) on image again photographed by the imaging device according to the above-mentioned control 321.

Meanwhile, in the operation 320, when no the brightness of the eye portion is saturated (the saturation by the reflection by the spectacles), for example, when the brightness average (e.g., except for a reflection portion of the gradation of 200 or more and a background portion of the gradation of about 20 or less) of the lighting on image has the gradation of about 50 or less of the lower limit value 350, since an occurrence of noise in the difference image may be present, the driver state recognizer 112 may be configured to generate the control signal to maintain the lighting for the front light or the side light in the lighting part 130, and generate the control signal to increase the exposure value to provide the control signal to the capture controller 111 (351). The driver state recognizer 112 may be configured to perform the eye position and open and close recognition using the lighting (e.g., LED) on image again photographed by the imaging device according to the above-mentioned control 321.

In the operation 350, when the brightness average of the lighting on image is greater than the gradation of about 50 and when the brightness average of the lighting on image is the upper limit gradation of about 100 or less 360, the driver state recognizer 112 may be configured to generate a control signal to turn off the lighting of front light or side light in the lighting part 130, and generate the control signal to maintain the exposure value without being changed, to provide the control signal to the capture controller 111 (361). When the condition in the operation 360 is not satisfied (e.g., there is weak reflection/fine reflection), the driver state recognizer 112 may be configured to generate the control signal to turn off the lighting of the front light or the side light in the lighting part 130, and generate the control signal to decrease the exposure value to provide the control signal to the capture controller 111 (362).

The driver state recognizer 112 may further be configured to capture the lighting off image according to the above-mentioned controls 361/362, capture the difference image of the lighting on image and the lighting off image based on the captured lighting off image, and verify whether to perform the eye position and open and close recognition using the difference image, after the capturing of the difference image as described above 370. For example, when a pixel having the brightness of 0 (or a brightness difference between the lighting on/off images of 0) is present in the difference image (it is possible when the number of pixels is a predetermined number or more), since no brightness is saturated and a motion of a subject (the face of the driver) is minimal, the eye position and open and close recognition may be performed using the difference image 371. When no pixel having the brightness of 0 is present in the difference image, the driver state recognizer 112 may be configured to perform the eye position and open and close recognition using the lighting on image 321.

FIGS. 4A-4C are photographs showing comparison results of a degree of brightness saturation between an original lighting on image and a difference image according to an exemplary embodiment of the present disclosure. The photographs of FIGS. 4A-4C are related to difference images 410, 420, 430 and original lighting on images 411, 421, 431 obtained by photographing the lighting on image and the lighting off image at a speed of 60 frames per second (fps).

As in 410 and 420 of FIG. 4C, in an eye region or other face regions, when external light such as side light/backlight by the light of the sun is strong, even though the exposure is decreased, a saturation region is present in the difference image due to a limit of a dynamic range of the imaging device 120. Therefore, it may be difficult to detect an eye/face of the driver. Therefore, it may be understood that it is advantageous to detect the face from the original lighting on images such as 411 and 421 of FIGS. 4B and 4C. In particular, the eye region may be used as a side light region to attenuate the exposure.

In addition, as in 430 and 431 of FIG. 4A, when no brightness of the eye portion is saturated (the saturation by the spectacles), when the driver state recognizer 112 according to the present disclosure adjusts the exposure to be decreased so that no brightness of the eye portion is saturated (the saturation by the spectacles) in the eye region (the eye detection candidate region), it was confirmed that the saturation region is removed from the difference image and a reduction effect of the reflection on the spectacles reliably exhibits.

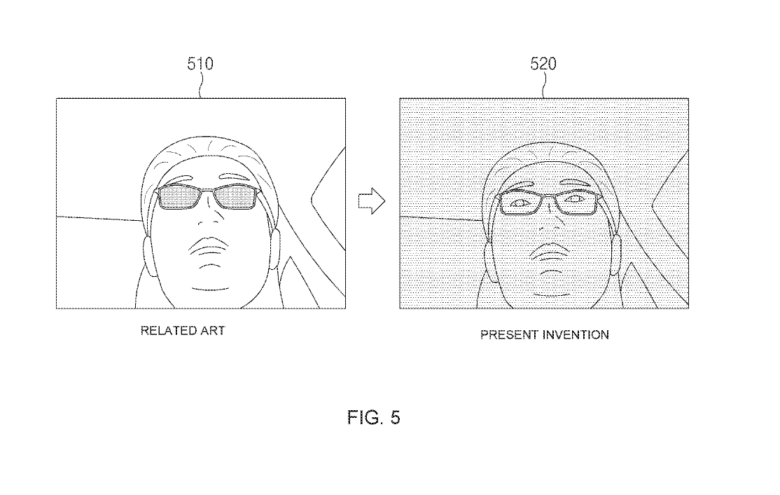

As a result, as in 510 of FIG. 5, according to an apparatus for capturing a face image according to the related art, a wearer of the spectacles in the daytime has a problem that a recognition rate thereof is significantly decreased due to the reflection of the light of the sun in the eye region. However, according to the present disclosure, as in 520 of FIG. 5, since the saturation region is removed from the difference image and the reduction effect of the reflection on the spectacles reliably shows, an eye region blind phenomenon by the reflection of the light of the sun in the spectacles of the wearer of the spectacles in the daytime is reduced, thereby making it possible to significantly improve performance of the eye detection and the eye open and close recognition.

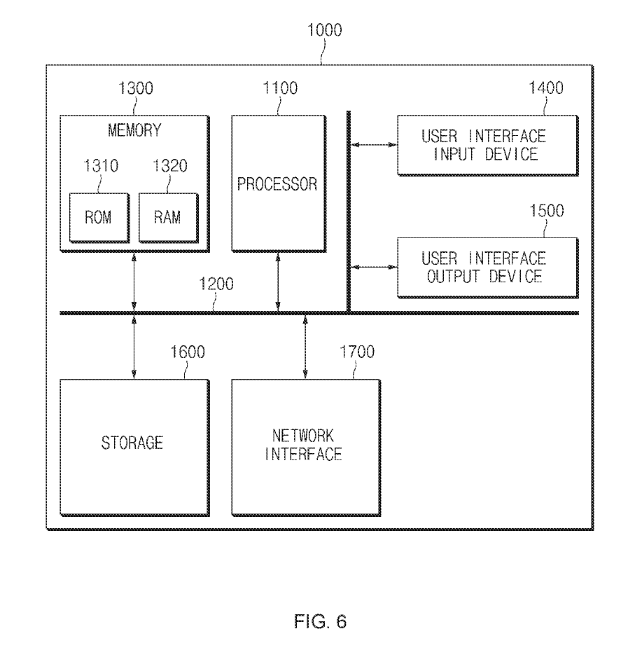

FIG. 6 is a diagram illustrating an example of a method for implementing a capture controller 110 of the apparatus 100 for capturing a face image according to an exemplary embodiment of the present disclosure. The capture controller 110 of the apparatus 100 for capturing a face image according to an exemplary embodiment of the present disclosure may be implemented by hardware, software, or a combination thereof. For example, the capture controller 110 may be implemented as a computing system 1000 as illustrated in FIG. 6.

The computing system 1000 may include at least one processor 1100, a memory 1300, a user interface input device 1400, a user interface output device 1500, a storage 1600, and a network interface 1700 connected via a bus 1200. The processor 1100 may be a central processing unit (CPU) or a semiconductor device executing processes for instructions which are stored in the memory 1300 and/or the storage 1600. The memory 1300 and the storage 1600 may include various types of volatile or non-volatile storing media. For example, the memory 1300 may include a read only memory (ROM) 1310 and a random access memory (RAM) 1320.

Accordingly, steps in the method or algorithm which is described in context with the exemplary embodiments disclosed in the present specification may be directly implemented in hardware, a software module, or a combination thereof which is executed by the processor 1100. The software module may be resided on a storing medium (i.e., the memory 1300 and/or the storage 1600) such as a RAM memory, a flash memory, a ROM memory, an erasable programmable read only memory (EPROM), an electrically erasable programmable read only memory (EEPROM), a register, a hard disk, a removable disk, or a compact disc-read only memory (CD-ROM). An exemplary storing medium may be coupled to the processor 1100 and the processor 1100 may read information from the storing medium and write the information into the storing medium. Alternatively, the storing medium may be integral with the processor 1100. The processor and the storing medium may also be resided within an application specific integrated circuit (ASIC). The ASIC may also be resided within a user terminal. Alternatively, the processor and the storing medium may also be resided within the user terminal as a separate component.

As described above, the apparatus 100 for capturing a face image according to the present disclosure may be configured to determine the reflection on the spectacles of a region around an eye within the face of the driver in real time and may more stably and effectively reduce the influence of the reflection from the spectacles through the exposure adjustment, without requiring an output for the difference image, by operating the general imaging device capable of performing an external exposure control for purpose of reducing the reflection on the spectacles in the vehicle to receive the lighting on/off images and performing a difference image processing in the electronic control unit (ECU) 110, thereby making it possible to significantly improve performance of the eye detection and the eye open and close recognition. In addition, safety may be improved to prevent an LED light irradiation from disturbing the driving of the driver through the LED off control of 1 frame per 2 frames.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus for capturing a face image for monitoring a driver state in a vehicle, comprising:
an imaging device configured to capture an image of a driver;
an electronic control unit configured to adjust an exposure for the imaging device; and
one or more light devices turned on or off by the imaging device or the electronic control unit,
wherein the electronic control unit is configured to determine whether brightness for a predetermined region within a face is saturated in the image captured by the imaging device, and determine whether to use a difference image between a lighting on image and a lighting off image.

2. The apparatus according to claim 1, wherein the electronic control unit is configured to determine whether the brightness is saturated in an eye detection candidate region based on the lighting on image captured by the imaging device when the lighting is turned on.

3. The apparatus according to claim 1, wherein the electronic control unit includes:
a driver state recognizer configured to determine whether the brightness is saturated and calculate the difference image; and
a capture controller configured to capture the lighting off image and the lighting on image from the imaging device.

4. The apparatus according to claim 1, wherein the electronic control unit is configured to perform a face detection in the lighting on image, and perform an eye detection based on the difference image when no the brightness is saturated.

5. The apparatus according to claim 1, wherein the electronic control unit is configured to:
perform an eye detection based on the lighting on image in a condition in which the brightness is saturated;
calculate a saturation prevention exposure value of the eye detection candidate region to perform the exposure adjustment of the imaging device; and
perform the eye detection based on the lighting on image which is re-photographed by the imaging device.

6. The apparatus according to claim 1, wherein whether the brightness is saturated is determined for the eye detection candidate region when the driver wears the spectacles in the daytime.

7. The apparatus according to claim 1, wherein the electronic control unit is configured to determine that the brightness is saturated when the number of pixels having predetermined brightness or greater within the eye detection candidate region in the lighting on image is a threshold value or greater.

8. The apparatus according to claim 1, wherein the electronic control unit is configured to perform an eye detection based on the lighting on image in a condition in which the brightness is saturated, and calculate a saturation prevention exposure value of the eye detection candidate region within a predetermined range for a brightness average within the eye detection candidate region in the lighting on image to perform the exposure adjustment of the imaging device.

9. The apparatus according to claim 1, wherein the electronic control unit is configured to perform an eye detection based on the difference image in a condition in which no the brightness is saturated, and capture the lighting off image by maintaining an exposure value for the imaging device when a brightness average of the lighting on image is within a predetermined range.

10. The apparatus according to claim 1, wherein the electronic control unit is configured to perform an eye detection based on the difference image in a condition in which no the brightness is saturated, operate the imaging device to decrease an exposure value for the camera when a brightness average of the lighting on image is greater than an upper limit value of a predetermined range, and capture the lighting off image.

11. The apparatus according to claim 1, wherein the electronic control unit is configured to operate the imaging device by increasing an exposure value for the imaging device when a brightness average of the lighting on image is a lower limit value or less of a predetermined range in a condition in which no the brightness is saturated, and perform an eye detection based on the lighting on image.

12. A method for capturing a face image for monitoring a driver state of a driver in a vehicle, comprising:
performing, by a controller, an exposure adjustment for an imaging device installed within the vehicle;
turning on and off, by the controller, one or more light devices installed within the vehicle; and
determining, by the controller, whether brightness for a predetermined region within a face is saturated in an image captured by the imaging device, and determining whether to use a difference image between a lighting on image and a lighting off image.

13. The method according to claim 12, wherein whether the brightness is saturated in an eye detection candidate region is determined based on the lighting on image captured by the imaging device when the lighting is turned on.

14. The method according to claim 12, further comprising:
performing, by the controller, a face detection in the lighting on image, and performing an eye detection based on the difference image in a condition in which no the brightness is saturated.

15. The method according to claim 12, further comprising:
performing, by the controller, an eye detection based on the lighting on image in a condition in which the brightness is saturated;
calculating, by the controller, a saturation prevention exposure value of the eye detection candidate region to perform the exposure adjustment of the imaging device; and
performing, by the controller, the eye detection based on the lighting on image which is re-photographed by the imaging device.

16. The method according to claim 12, wherein it is determined that the brightness is saturated when the number of pixels having predetermined brightness or greater within the eye detection candidate region in the lighting on image is a threshold value or greater.

17. The method according to claim 12, further comprising:
performing, by the controller, an eye detection based on the lighting on image when the brightness is saturated; and
calculating, by the controller, a saturation prevention exposure value of the eye detection candidate region within a predetermined range for a brightness average within the eye detection candidate region in the lighting on image to perform the exposure adjustment of the imaging device.

18. The method according to claim 12, further comprising:
performing, by the controller, an eye detection based on the difference image when no the brightness is saturated, and the lighting off image is captured by maintaining an exposure value for the imaging device when a brightness average of the lighting on image is within a predetermined range.

19. The method according to claim 12, further comprising:
performing, by the controller, an eye detection based on the difference image in a condition no the brightness is saturated, the imaging device is operated to decrease an exposure value for the imaging device when a brightness average of the lighting on image is greater than an upper limit value of a predetermined range, and the lighting off image is captured.

20. The method according to claim 12, wherein the imaging device is operated by increasing an exposure value for the imaging device when a brightness average of the lighting on image is a lower limit value or less of a predetermined range in a condition in which no the brightness is saturated, and an eye detection is performed based on the lighting on image.
